(19) United States
(12) Patent Application Publication
(10) Pub. No.: US 2008/0295714 A1
(43) Pub. Date: Dec. 4, 2008

(54) ROTARY PRINTING PRESS

(75) Inventors: Oliver BLEISCH, Plauen (DE); Matthias Wermuth, Weischlitz (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/130,712

(22) Filed: May 30, 2008

(30) Foreign Application Priority Data
Jun. 1, 2007 (DE) 10 2007 025 499.9

(51) Int. Cl. B41F 13/24

(52) U.S. Cl. 101/232

(57) ABSTRACT

A rotary printing press, which has a printing tower with a first printing unit, which is arranged on a support base, and a second printing unit, which is arranged above the first printing unit, and a substructure arrangement, is disclosed. The substructure arrangement supports the second printing unit so that the weight of the second printing unit bears on the substructure arrangement.

This application claims the priority of German Patent Document No. 10 2007 025 499.9, filed Jun. 1, 2007, the disclosure of which is expressly incorporated by reference herein.

### BACKGROUND AND SUMMARY OF THE INVENTION

The invention relates to a rotary printing press, and in particular a rotary printing press, which, even in the case of a high print rate and high system flexibility, can nevertheless be installed in an especially space saving manner at its respective set-up location.

In the domain of rotary printing press engineering there is a persistent need to minimize space requirements for printing presses in the case of high print rates and high system flexibility and/or to utilize the existing set-up space in an optimal way.

The reason for this is firstly that in many cases new printing presses are installed in already existing buildings, where available space is restricted. Furthermore, printing presses are always becoming more efficient, more complex and more multifunctional, whereby additional functions of the printing press should not take up any additional space as far as possible.

On the other hand, this persistent need is justified in that, in the case of larger printing presses, in particular printing presses that are stacked higher, more manpower is required to operate the system, which can considerably increase labor costs. As a result, the operators of printing systems are striving to procure systems that are as compact as possible, which can be operated with the lowest possible personnel costs.

In order to meet this demand by printing press operators, most recently the trend has been integrating more and more print positions into one printing unit. In particular this has a positive effect in the case of stacked rotary printing presses having printing units arranged in printing towers, in which either stories of the printing press can be saved in this manner or more print positions or printing couples can be accommodated in the existing space.

A conventional printing unit, like those used in these types of stacked rotary printing presses, is for example an H-printing unit with an 8-cylinder system (blanket-to-blanket) used by MAN Roland AG in their CROMOMAN printing press. Two such H-printing units are positioned or stacked on top of one another in the CROMOMAN to form a printing tower, whereby, in the case of high color and page capacity, so-called 4/4 color printing for example (applying four colors to each page of a to-be-printed paper web) can be realized in a tight space with short web paths for optimal register accuracy. The paper web in this configuration is essentially fed vertically through the printing units, whereby each printing unit has four print positions or printing couples, i.e., two for each side of the paper web.

Newly developed printing units, in which more print positions are now integrated, have a higher weight as compared to conventional printing units. Since, in the case of stacked rotary printing presses, such as the CROMOMAN for example, the respective upper printing unit is placed directly on the respective lower printing unit, the entire weight of the upper printing unit is borne by the lower printing unit. If the weight of the printing units is now increased, this can lead to undesirable deformations on the lower printing unit.

Furthermore, these types of system configurations are limited as a rule to the effect that printing units that are stacked on top of one another to form a printing tower should have the same width and depth dimensions as far as possible in order to make this type of stacking on top of one another possible. In addition, this arrangement of the printing units can cause vibrations of the one printing unit of the printing tower to be transferred to the other printing unit of the printing tower.

The invention is based on the objective of making a rotary printing press available in which printing units stacked on top of one another are isolated physically from one another in such a way that undesired interactions between the printing units are safely avoided.

According to the invention, a rotary printing press has a printing tower with a first printing unit, which is arranged on a support base, and a second printing unit, which is arranged above the first printing unit, and a substructure arrangement, which supports the second printing unit so that the weight of the second printing unit bears on the substructure arrangement.

Among other things, such a system configuration offers the advantage that, because the weight of the upper printing unit bears on the substructure arrangement, the lower printing unit is not subjected to any excess stress that could produce deformations of the printing unit. These types of deformations can, for example, be deformations to the bearing fit or the bearings for the cylinders or rollers of the printing unit.

Furthermore, the two printing units are vibrationally isolated from each other thereby sparing the bearings of the printing units and improving print quality.

According to a development of the invention, the substructure arrangement has a horizontal section and a vertical section.

This embodiment of the substructure arrangement is rugged and can be integrated into the printing press in an easy way.

According to a development of the invention, the vertical section has upper ends and lower ends and the horizontal section has lateral ends, which are supported on the upper ends of the vertical section.

In the case of this embodiment, it is possible to place the horizontal section on the upper ends of the vertical section, whereby a support is produced in a simple way.

According to a development of the invention, the lower ends of the vertical section are supported on the support base.

With this embodiment, it is possible to place the lower ends of the vertical section in a simple manner on the support base so that the support base bears both printing units as well as the substructure arrangement.

According to a development of the invention, the horizontal section extends between the first printing unit and the second printing unit.

This embodiment can be realized for example as a continuous or interrupted gantry design or as a self-supporting design with the use of steel supports and/or concrete elements, for example, wherein the horizontal section is fastened to, or supported on, the vertical section. This can be integrated into the printing press cost-effectively and in a simple manner.

According to a development of the invention, the horizontal section has an upper surface that is arranged on the second printing unit.

This embodiment is advantageous to the extent that the upper printing unit is positioned in the same manner as the lower printing unit, namely upright on its lower side so that no additional fastening agents or structural modifications need to be provided for the upper printing unit as compared to the lower printing unit in order to set it up.

According to a development of the invention, the horizontal section has a width dimension between its lateral ends that is at least as great as the width dimension of the first printing unit, and extends essentially parallel thereto.

This embodiment guarantees a secure state of the upper printing unit and its correct alignment with respect to the lower printing unit of the printing tower. Furthermore, if the width dimension of the horizontal section is chosen to be, for example, greater than that of the lower printing unit, the upper, or second, printing unit can have a greater width dimension than the lower, or first, printing unit. As a result, there is increased flexibility in the system configuration.

According to a development of the invention, the vertical section has a height dimension between its lower and upper ends that is at least as great as the height dimension of the first printing unit, and extends essentially parallel thereto.

The advantage of this embodiment is that, on the one hand, the substructure arrangement can be realized with minimal dimensions and, on the other hand, if the height dimension of the vertical section is greater than the height dimension of the first printing unit, space can be created between the two printing units if necessary.

According to a development of the invention, the vertical section has at least two vertical elements, each of which has an upper end and a lower end, wherein the lateral ends of the horizontal section are supported on the upper ends of the vertical elements.

This gantry-shaped design of the substructure arrangement is constructed simply, rugged and cost-effective.

According to a development of the invention, the first printing unit is arranged between at least two vertical elements.

The advantage of this embodiment is that, when several of these types of printing towers are arranged side-by-side, a modular structure of the individual printing towers is guaranteed so that printing towers can be added or omitted on an as-needed basis or customer-specifically.

According to a development of the invention, the horizontal section has two longish support elements arranged alongside one another and at a distance from one another, each having two longitudinal ends, wherein the two longitudinal ends of the support elements are each supported on the upper ends of the vertical section.

The advantage of this embodiment is that, on the one hand, the upper printing unit can be supported in a material saving manner and, on the other hand, space is available between the support elements that can be used for design-related and technological purposes.

According to developments of the invention, the printing units each have at least one print position, at least two print positions or eight print positions.

The advantage of this embodiment is that a customer-specific and variable configuration of the printing press is possible. Moreover, an extremely powerful, variably configurable and compact printing press can be achieved because, for example, two printing units each having eight print positions are arranged in a stacked manner. In other words, such a printing press makes it possible to handle multifaceted print requirements with high print rates with a lower or at least not greater amount of space as compared to earlier printing presses.

According to a development of the invention, the vertical elements are integrated into two opposing side walls of the first printing unit.

The advantage of this embodiment is that the substructure arrangement can be integrated into the printing press in a manner that especially saves space and materials, thereby reducing costs.

According to a development of the invention, the vertical elements are formed by two opposing side walls of the first printing unit, wherein the rotational axes of the cylinders of the first printing unit extend essentially parallel to these side walls.

In other words, the vertical elements are formed by those side walls of the first printing unit, which do not accommodate any bearings for the cylinders of the first printing unit, such as, for example, blanket cylinders, impression cylinders and ink form cylinders.

Additional material and costs are saved by this embodiment, wherein it is guaranteed nevertheless that the side walls of the first printing unit, which accommodate the bearings for the cylinders, are completely free of any printing stress from the second printing unit.

According to a development of the invention, a first web guide is provided between the first printing unit and the second printing unit for feeding in and/or feeding out a to-be-printed or printed web between the first printing unit and the second printing unit.

On the one hand, the advantage of this embodiment is that a to-be-printed or printed web can be guided from an adjacent reel changer or an adjacent printing tower between the first printing unit and the second printing unit for further processing such as folding. On the other hand, this embodiment makes it possible to feed in a to-be-printed or printed web from an adjacent reel changer or an adjacent printing tower into the first and the second printing unit for printing. This increases the flexibility of the printing press with respect to the possible printing variations.

According to a development of the invention, the first web guide has a turning device and/or a diverting device for turning at least one web into and/or out of the printing units.

With this embodiment it is possible in a simple way to turn a to-be-printed or printed web into and/or out of one of the printing units.

Thus, for example, after passing through one of the printing units, the web can be guided horizontally out of the printing unit turned by 90 degrees for example relative to the vertical axis by means of a turner bar and then conveyed to the former of a folding unit. A second web can then, for example, be turned into the other of the printing units by means of a guide roller and/or a turner bar in order to be printed in this printing unit. This second web can be introduced starting from an adjacent printing tower or an adjacent reel changer.

According to a development of the invention, the first web guide has a web securing device.

With this embodiment, devices such as a web-tension control device and/or a register control device, for example, can be integrated in a space-saving manner into the intermediate space between the first and second printing units. As a result, the printing press can be designed to be even more compact.

According to a development of the invention, the first web guide is mounted on the horizontal section.

In other words, according to this embodiment, the first web guide can be integrated or built into the horizontal section in a simple manner thereby saving additional space and material. This is also beneficial for the compactness of the printing press and reduces costs since no additional assembly devices have to be provided for the first web guide.

According to a development of the invention, a second web guide is integrated into the vertical section for guiding at least one to-be-printed or printed web through the vertical section.

The advantage of this embodiment is one or more webs can be conveyed through the printing press in a space saving and flexible manner. Thus, for example, a printed or to-be-printed web can be conveyed from an adjacent printing tower or an adjacent reel changer to the second printing unit for example and be turned into it for printing. In this manner, it is of course possible to convey one or more webs in a simple way to a folding unit for further processing.

According to a development of the invention, a third web guide is provided below the first printing unit for feeding a to-be-printed or printed web into or out of the first printing unit.

This embodiment makes it possible to adapt the printing press even more flexibly to the respective print job being performed. Thus, for example, it is conceivable to feed a web into the printing tower via the third web guide, feed the printed web out of the second printing unit and then convey the web to a subsequent printing tower or a subsequent folding unit.

On the other hand, it is conceivable for example to turn a web between the first and second printing unit into the first printing unit, to guide the printed web out of the first printing unit via the third web guide and then convey the web to a subsequent printing tower or a subsequent folding unit. Of course, other variations of the web guide are possible depending upon requirements.

According to a development of the invention, the third web guide has a turning device and/or a diverting device for turning the web into and/or out of the first printing unit.

With this embodiment, it is possible in a simple manner to turn a to-be-printed or printed web into and/or out of this printing unit.

Thus, for example, after passing through the first printing unit, the web can be guided horizontally out of the first printing unit turned by 90 degrees for example relative to the vertical axis by means of a turner bar and then conveyed to an adjacent printing tower or to the former of a folding unit. On the other hand, it is possible, for example, to guide the web horizontally, but not turned vertically, out of the first printing unit or into the same by means of a guide roller.

According to a development of the invention, the printing tower above the second printing unit comprises at least one additional printing unit and at least one additional substructure arrangement, which supports the additional printing unit so that the weight of the additional printing unit bears on the additional substructure arrangement.

This embodiment makes threefold stacking or a fourfold stacking of printing units in the printing tower possible, for example, whereby the printing press can be installed at the respective installation location in an even more space-saving manner. Moreover, this arrangement of one or more additional printing units makes it possible to adapt the printing press even more flexibly to the respective print jobs being performed.

According to a development of the invention, the additional substructure arrangement is supported on the substructure arrangement of the first and the second printing unit.

This embodiment creates a cost-effective and space-saving attainment, in which the substructure arrangement of the first and the second printing unit is simply expanded upwardly or stacked so that one or more additional printing units can be arranged, wherein the modular structure of the printing tower is retained.

According to a development of the invention, a fourth web guide is provided above the second printing unit for feeding a to-be-printed or printed web at least into or out of the second printing unit.

This embodiment makes it possible to adapt the printing press even more flexibly to the respective print job being performed. Therefore, it is conceivable, for example, to feed a web into the printing tower via the fourth web guide, feed the printed web out of the first printing unit and then convey the web to a subsequent printing tower or a subsequent folding unit.

On the other hand, it is conceivable, for example, to turn a web between the second printing unit and a third printing unit arranged above it into the third printing unit, to feed the printed web out of the third printing unit via a fifth web guide arranged above the third printing unit and then to convey the web to a subsequent printing tower or a subsequent folding unit. Of course, other variations of the web guide are also possible depending upon requirements.

According to a development of the invention, the fourth web guide has a turning device and/or a diverting device for turning the web at least into and/or out of the second printing unit.

With this embodiment it is possible in a simple manner to turn a to-be-printed or printed web into and/or out of this printing unit.

Thus, for example, after passing through the second printing unit, the web can be guided horizontally out of the uppermost printing unit turned by 90 degrees for example relative to the vertical axis by means of a turner bar and then conveyed to an adjacent printing tower or to the former of a folding unit. On the other hand, it is possible, for example, to guide the web horizontally, but not turned vertically, out of the second printing unit or into the same by means of a guide roller.

In this context, according to yet another development of the invention, a web guide is provided above an uppermost printing unit for feeding a to-be-printed or printed web into or out of the uppermost printing unit.

According to yet another development of the invention, the web guide above the uppermost printing unit has a turning device and/or a diverting device for turning the web into and/or out of the uppermost printing unit.

### BRIEF DESCRIPTION OF THE DRAWINGS

FIG. 1 shows a schematic front view of a first embodiment of an inventive rotary printing press.

FIG. 2 shows a schematic top view of the rotary printing press from FIG. 1.

FIG. 3 shows a schematic front view of a second embodiment of an inventive rotary printing press.

### DETAILED DESCRIPTION OF THE DRAWINGS

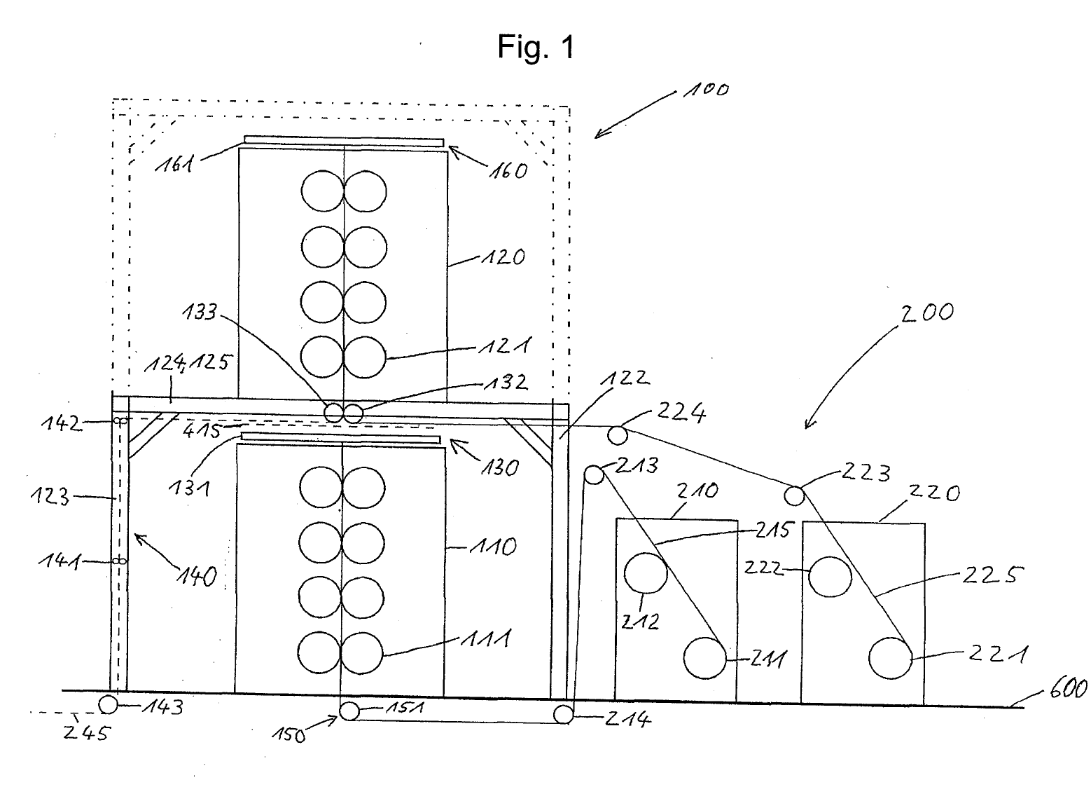

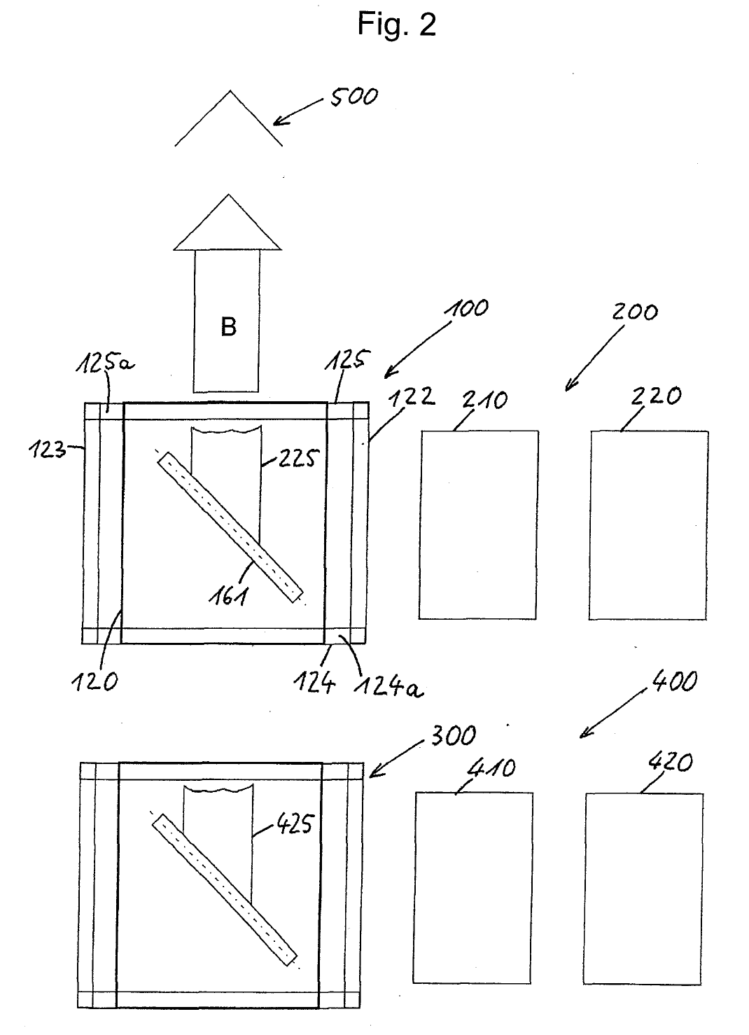

A first embodiment of the inventive rotary printing press (hereinafter printing press) is described, making reference to FIG. 1 and FIG. 2.

As FIG. 1 shows, the inventive printing press has a printing tower 100 with a first printing unit 110, which is arranged on a support base 600, and a second printing unit 120, which is arranged above the first printing unit 110, and a substructure arrangement 122-125, which supports the second printing unit 120 so that the weight of the second printing unit 120 bears on the substructure arrangement 122-125.

Each of the printing units 110, 120 in this embodiment has eight print positions 111 or 121, wherein two print positions 111 or 121 respectively are diametrically opposed in the printing unit 110, 120 so that four such pairs 111 and 111 or 121 and 121 are formed by the diametrically opposed print positions. The four pairs are stacked on top of one another in the vertical direction.

Each print position 111, 121 has a cylinder for printing on a to-be-printed web and an impression cylinder for pressing against the web on the cylinder for printing, whereby, in the case of each pair of diametrically opposed print positions, the cylinder for printing on the web of the one print position respectively forms the impression cylinder for the other print position.

The support base 600 in this embodiment is the floor of a production hall in which the printing press is set up.

The substructure arrangement 122-125 according to this embodiment has a vertical section, which is formed by two vertically upright wall elements 122, 123 that are arranged opposite and parallel from one another at distance from one another, as well as a horizontal section, which is formed by two longish, horizontally arranged support elements 124, 125, each having two longitudinal ends.

The wall elements 122, 123 each have a lower end, which is supported on the support base 600, an upper end and two lateral ends.

As FIG. 2 shows, the two support elements 124, 125 are arranged alongside one another so that a support element 124, 125 connects the two opposing, lateral ends of the two wall elements 122, 123 respectively with one another. The two longitudinal ends of the support elements 124, 125 rest on the upper ends of the wall elements 122, 123 so that they are supported thereupon.

In other words, the substructure arrangement that is related to the view in FIG. 1 is embodied to be gantry-shaped and the one related to the view in FIG. 2 is embodied to be box-shaped.

As FIG. 1 shows, the first printing unit 110 is arranged between the wall elements 122, 123, wherein the wall elements 122, 123 each have a height dimension (related to FIG. 1) between their lower and upper ends, which is somewhat greater than the height dimension of the first printing unit 110 and extends essentially parallel thereto. In other words, the height dimension of the wall elements 122, 123 is greater than that of the first printing unit 110 by 300 mm to 500 mm for example.

The support elements 124, 125 have a width dimension (related to FIG. 1) or a length dimension between their lateral ends (related to FIG. 1) or longitudinal ends, which is somewhat greater than the width dimension of the first printing unit 110 and extends essentially parallel thereto. In other words, the length dimension of the support elements 124, 125 is greater than the width dimension of the first printing unit 110 by 1000 mm to 2000 mm for example.

The distance at which the support elements 124, 125 are arranged alongside one another is somewhat less than the depth dimension (related to FIG. 1) of the second printing unit 120. The support elements 124, 125 each have an upper surface 124a or 125a on which the second printing unit 120 is positioned.

In other words, the two support elements 124, 125 extend horizontally between the first printing unit 110 and the second printing unit 120.

As shown in FIG. 1 and FIG. 2, a first printing web feed device 200, which has two reel changers 210 and 220, is arranged next to the printing tower 100 on the support base 600. Printing web rollers 211, 212 or 221, 222 can be accommodated in the reel changers 210, 220. In this embodiment, the reel changer 210 supplies the first printing unit 110 with a to-be-printed web or a printing web 215 and the reel changer 220 supplies the second printing unit 120 with a printing web 225.

The printing web feed device 200 also has two guide rollers 213 and 214 for guiding the printing web 215 from the first reel changer 210 to the first printing unit 110 and two guide rollers 223 and 224 for guiding the printing web 225 from the second reel changer 220 to the second printing unit 120.

As shown in FIG. 2, a second printing tower 300 with a second printing web feed device 400 is arranged parallel to the first printing tower 100 with the first printing web feed device 200 (or as related to FIG. 1 in front of it). In this embodiment, the second printing tower 300 and the second printing web feed device 400 are embodied just like the first printing tower 100 and the first printing web feed device 200.

As FIG. 1 shows, a first web guide 130 is provided between the first printing unit 110 and the second printing unit 120 for feeding in and/or feeding out a to-be-printed or printed web between the first printing unit 110 and the second printing unit 120.

According to this embodiment, the first web guide 130 has a turner bar 131, which is fastened on the support elements 124, 125 above the first printing unit 110 by means of suitable assembly means as well as two guide rollers 132 and 133, which are rotatably mounted on the support elements 124, 125 above the turner bar 131 and below the second printing unit 120 by means of suitable assembly means.

The turner bar 131 is used for a 90 degree turn (in the direction of arrow B in FIG. 2) of the printing web 215, when it exits from the first printing unit 110 after a printing process has taken place. The guide rollers 132, 133 are used to divert the printing web 225 into the second printing unit 120.

In other words, according to this embodiment, the printing web 225 is guided from the second reel changer 220 via the guide rollers 223 and 224 to the second printing unit 120, then turned into the second printing unit 120 via the guide roller 132 and then guided essentially vertically through the second printing unit 120.

As shown in FIG. 1, a printing web 415 can be guided from the adjacent, second printing tower 300 between the turner bar 131 and the guide rollers 132, 133. This printing web 415 is the printing web, which can be turned by 90 degrees out of the printing unit of the second printing tower 300 that is arranged at the same level as the first printing unit 110.

According to this embodiment, the first web guide 130 also has a web securing device with a web-tension control device and a register control device for the printing web 415 that can be guided through. The web securing device is also mounted to the support elements 124, 125 by means of suitable assembly means.

As shown in FIG. 1, a second web guide 140 is integrated into the left wall element 123 in FIG. 1 for guiding at least one printing web through the wall element 123. According to this embodiment, the second web guide 140 has two roller pairs 141 and 142, wherein, in the case of each pair, two rollers respectively are arranged pressing against one another and the printing web between the rollers pressing against each other can be guided vertically upwardly. Arranged below the support base 600 is a guide roller 143 via which a printing web 245 can be guided from a reel changer (not shown) other than the second reel changer 220 into the second web guide 140 and then via the guide roller 133 of the first web guide 130 into the second printing unit 120.

As shown in FIG. 1, a third web guide 150 is provided below the first printing unit 110 for feeding a printing web 215 into or out of the first printing unit 110.

According to this embodiment, the third web guide 150 has a guide roller 151 for diverting a printing web 215 into the first printing unit 110.

In other words, according to this embodiment, the printing web 215 is conveyed from the first reel changer 210 via the guide rollers 213 and 214 to the first printing unit 110, then turned via the guide roller 151 into the first printing unit 110 and then guided essentially vertically through the first printing unit 110.

When the printing web 215 exits at the top from the first printing unit 110, the printing web 215 is guided via the turner bar 131, whereby the printing web 215 is rotated by 90 degrees around its longitudinal axis and turned to the horizontal so that the printing web runs in the direction of arrow B in FIG. 2.

As shown in FIG. 1, a fourth web guide 160 is provided above the second printing unit 120, which is the uppermost printing unit in this embodiment, for feeding a printing web at least into or out of the second printing unit 120.

According to this embodiment, the fourth web guide 160 has a turner bar 161 for a 90 degree turn (in the direction of arrow B in FIG. 2) of the printing web 225, when it exits from the second printing unit 120 after the printing process has taken place.

As shown in FIG. 2, the printing press also has a folding device 500. According to this embodiment, the folding device 500 has a former (standard former) for folding the printing web 215 of the first printing unit 110 and a former (balloon former) for folding the printing web 225 of the second printing unit 120.

As mentioned above, the printing web 415 of the adjacent, second printing tower 300 can be guided through between the first printing unit 110 and the second printing unit 120 of the first printing tower 100 and then be conveyed to the folding device 500 for folding for example.

As shown in FIG. 1 by a dashed-and-dotted line, the printing tower 100 can be stacked as desired as the need arises, by arranging an additional substructure arrangement on the substructure arrangement 122-125, on which additional substructure arrangement an additional printing unit can be mounted.

This type of additional substructure arrangement can be embodied just like the substructure arrangement 122-125 or can be modified as needed.

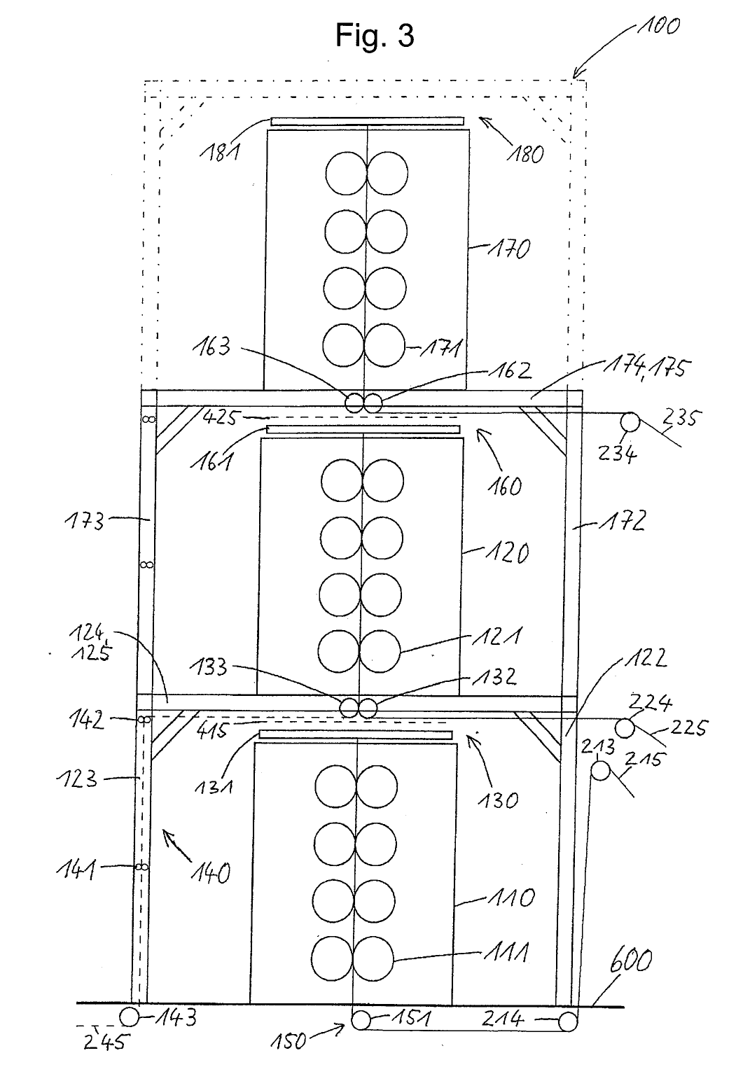

A second embodiment of the inventive rotary printing press is described in the following making additional reference to FIG. 3.

As FIG. 3 shows, the second embodiment is equivalent to the first embodiment with the exception that the printing tower 100 above the second printing unit 120 has a third printing unit 170 and an additional substructure arrangement 172-175, which supports the third printing unit 170 so that the weight of the third printing unit 170 bears on the additional substructure arrangement 172-175.

The additional substructure arrangement 172-175, which is embodied just like the substructure arrangement 122-125 of the first and the second printing unit 110, 120, is supported on the substructure arrangement 122-125. The third printing unit 170 is placed on the surface formed by the support elements 174, 175 of the additional substructure arrangement 172-175.

According to the second embodiment, the fourth web guide 160 has turner bar 161, which is fastened to the support elements 174, 175 above the second printing unit 120 by means of suitable assembly means, as well as two guide rollers 162 and 163, which are rotatably mounted on the support element 174, 175 above the turner bar 161 and below the third printing unit 170 by means of suitable assembly means.

The turner bar 161 is used for a 90 degree turn (in the direction of arrow B in FIG. 2) of the printing web 225, when it exits from the second printing unit 120 after the printing process has taken place. The guide rollers 162, 163 are used to divert a printing web 235 made available by a third reel changer (not shown) into the third printing unit 170.

In other words, according to this second embodiment, the printing web 235 is guided from the third reel changer via guide rollers (also not shown) and guide rollers 234 to the third printing unit 170, then turned via the guide roller 162 into the third printing unit 170 and then guided essentially vertically through the third printing unit 170.

As shown in FIG. 3, a printing web 425 can be guided from the adjacent, second printing tower 300 between the turner bar 161 and the guide rollers 162, 163. This printing web 425 is the printing web, which can be turned by 90 degrees out of the printing unit of the second printing tower 300 that is arranged at the same level as the second printing unit 120.

According to this embodiment, the fourth web guide 160 also has a web securing device with a web tension control device and a register control device for the printing web 425 that can be guided through. The web securing device is also mounted on the support elements 174, 175 by means of suitable assembly means.

As shown in FIG. 3, a fifth web guide 180 is provided above the third printing unit 170, which is the uppermost printing unit in this second embodiment, for feeding a printing web into or out of the third or uppermost printing unit 170.

According to this embodiment, the fifth web guide 180 has a turner bar 181 for a 90 degree turn (in the direction of arrow B in FIG. 2) of the printing web 235, when it exits from the third printing unit 170 after the printing process has taken place.

As mentioned and described above, the printing press has a folding device 500 and can guide the printing web 425 of the adjacent, second printing tower 300 between the second printing unit 120 and the third printing unit 170 of the first printing tower 100 and then convey it to the folding device 500 for folding for example.

As shown in FIG. 3 by a dashed-and-dotted line, the printing tower 100 can be stacked as desired as the need arises, by arranging an additional substructure arrangement on the substructure arrangement 172-175, on which additional substructure arrangement an additional printing unit can be mounted.

This other additional substructure arrangement can also be embodied just like the substructure arrangement 122-125 or can be modified as needed.

### LIST OF REFERENCE NUMERALS

100 First printing tower:
110 First printing unit
111 Print position
120 Second printing unit
121 Print position
122 Wall element
123 Wall element
124 Support element
125 Support element
130 First web guide
131 Turner bar
132 Guide roller
133 Guide roller
140 Second web guide
141 Roller pair
142 Roller pair
143 Guide roller
150 Third web guide
151 Guide roller
160 Fourth web guide
161 Turner bar
162 Guide roller
163 Guide roller
170 Third printing unit
171 Print position
172 Wall element
173 Wall element
174 Support element
175 Support element
180 Fifth web guide
181 Turner bar
200 First printing web feed device
210 First reel changer (first printing web feed device)
211 Printing web roller
212 Printing web roller
213 Guide roller
214 Guide roller
215 Printing web
220 Second reel changer (first printing web feed device)
221 Printing web roller
222 Printing web roller
223 Guide roller
224 Guide roller
225 Printing web
234 Guide roller
235 Printing web
300 Second printing tower
400 Second printing web feed device
410 First reel changer (second printing web feed device)
415 Printing web
420 Second reel changer (second printing web feed device)
425 Printing web
500 Folding device
600 Support base
B Run direction of the web towards the folding device

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A rotary printing press, comprising:
a printing tower with:
a first printing unit, which is arranged on a support base;
a second printing unit, which is arranged above the first printing unit; and
a substructure arrangement, which supports the second printing unit so that a weight of the second printing unit bears on the substructure arrangement.

2. The rotary printing press according to claim 1, wherein the substructure arrangement has a horizontal section and a vertical section.

3. The rotary printing press according to claim 2, wherein the vertical section has upper ends and lower ends, and wherein the horizontal section has lateral ends which are supported on the upper ends of the vertical section.

4. The rotary printing press according to claim 3, wherein the lower ends of the vertical section are supported on the support base.

5. The rotary printing press according to claim 2, wherein the horizontal section extends between the first printing unit and the second printing unit.

6. The rotary printing press according to claim 2, wherein the horizontal section has an upper surface on which the second printing unit is arranged.

7. The rotary printing press according to claim 2, wherein the horizontal section has lateral ends and wherein a width dimension between the lateral ends is at least as great as a width dimension of the first printing unit, and wherein the width dimension extends essentially parallel to the first printing unit.

8. The rotary printing press according to claim 2, wherein the vertical section has lower and upper ends and wherein a height dimension between the lower and upper ends is at least as great as a height dimension of the first printing unit, and wherein the height dimension extends essentially parallel to the first printing unit.

9. The rotary printing press according to claim 2, wherein the vertical section has at least two vertical elements, each of which has an upper end and a lower end, and wherein lateral ends of the horizontal section are supported on the upper ends of the vertical elements.

10. The rotary printing press according to claim 9, wherein the first printing unit is arranged between the at least two vertical elements.

11. The rotary printing press according to claim 2, wherein the horizontal section has two support elements arranged alongside one another and at a distance from one another, each having two longitudinal ends, and wherein the two longitudinal ends of the support elements are each supported on upper ends of the vertical section.

12. The rotary printing press according to claim 1, wherein the first and second printing units each have at least one print position, at least two print positions, or eight print positions.

13. The rotary printing press according to claim 9, wherein the vertical elements are integrated into two opposing side walls of the first printing unit.

14. The rotary printing press according to claim 9, wherein the vertical elements are formed by two opposing side walls of the first printing unit, and wherein a rotational axes of cylinders of the first printing unit extend essentially parallel to the side walls.

15. The rotary printing press according to claim 2, wherein a first web guide is provided between the first printing unit and the second printing unit for feeding in and/or feeding out a to-be-printed or printed web between the first printing unit and the second printing unit.

16. The rotary printing press according to claim 15, wherein the first web guide has a turning device and/or a diverting device for turning at least one web into and/or out of the first and second printing units.

17. The rotary printing press according to claim 15, wherein the first web guide has a web securing device.

18. The rotary printing press according to claim 15, wherein the first web guide is mounted on the horizontal section.

19. The rotary printing press according to claim 15, wherein a second web guide is integrated into the vertical section for guiding at least one to-be-printed or printed web through the vertical section.

20. The rotary printing press according to claim 19, wherein a third web guide is provided below the first printing unit for feeding a to-be-printed or printed web into or out of the first printing unit.

21. The rotary printing press according to claim 20, wherein the third web guide has a turning device and/or a diverting device for turning the web into and/or out of the first printing unit.

22. The rotary printing press according to claim 1, wherein the printing tower above the second printing unit comprises at least one additional printing unit and at least one additional substructure arrangement, which supports the additional printing unit so that a weight of the additional printing unit bears on the additional substructure arrangement.

23. The rotary printing press according to claim 22, wherein the additional substructure arrangement is supported on the substructure arrangement of the first and second printing units.

24. The rotary printing press according to claim 20, wherein a fourth web guide is provided above the second printing unit for feeding a to-be-printed or printed web at least into or out of the second printing unit.

25. The rotary printing press according to claim 24, wherein the fourth web guide has a turning device and/or a diverting device for turning the web at least into and/or out of the second printing unit.

26. The rotary printing press according to claim 1, wherein a web guide is provided above the second printing unit for feeding a to-be-printed or printed web into or out of the second printing unit.

27. The rotary printing press according to claim 26, wherein the web guide has a turning device and/or a diverting device for turning the web into and/or out of the second printing unit.
